(19) United States
(12) Patent Application Publication
(10) Pub. No.: US 2026/0268807 A1
(43) Pub. Date: Sep. 10, 2026

(54) SERIALIZED AND CUSTOMIZED HOLOGRAM SCRATCH OFF FOR TRANSACTION CARDS

(71) Applicant: Multi Packaging Solutions, Inc., Atlanta, GA (US)

(72) Inventor: Ken GLINERT, Atlanta, GA (US)

(21) Appl. No.: 19/559,170

(22) Filed: Mar. 6, 2026

Related U.S. Application Data
(60) Provisional application No. 63/767,720, filed on Mar. 6, 2025.

(51) Int. Cl. G09F 1/00

(52) U.S. Cl. CPC G09F 1/00

(57) ABSTRACT

A prepaid gift assembly includes a first panel coupled to a second panel. The prepaid gift assembly also includes a redemption code at least partially enclosed within the packaging and located between the first panel and the second panel, a foil disposed over the redemption code to conceal the redemption code, an activation code at least partially enclosed within the packaging, and a foil reference label disposed on an external surface of the packaging. The foil includes a printing. The activation code is located between the first panel and the second panel and positioned adjacent to the redemption code. Additionally, the foil reference label includes a reference printing that is configured for comparing to the printing of the foil to determine whether the foil remains intact.

### TECHNICAL FIELD

This disclosure relates to prepaid gift assemblies, and more particularly, to counterfeit preventative prepaid gift packaging.

### BACKGROUND

Prepaid cards, such as gift cards and electronic gift cards, have become more prevalent and popular in many consumer industries. For example, a customer may visit a local hardware or grocery store and purchase prepaid gift cards for a variety of categories, including restaurants, clothing, hardware, groceries, electronics, online stores, or a combination thereof. As popularity of prepaid cards continues to increase so does the need for adequate protection of the prepaid cards. Often, a fraudulent individual (i.e., a “fraudster”) may walk into a store that sells prepaid cards and place counterfeit barcodes over the cards’ barcodes or identification information. When a genuine customer loads a card with money at the store’s register, the counterfeit barcode is scanned, thereby transferring the customer’s money to the fraudster’s account. As a result, the fraudster quickly spends or moves the funds before the customer can use the prepaid card, thereby rendering the prepaid card worthless.

To combat the increase in prepaid card fraud, prepaid card and packaging manufacturers have developed a variety of ways to prevent tampering, to indicate if a prepaid card packaging has been tampered with, or both. For example, prepaid card barcodes have become increasingly more complex by including basic gradients or colors to prevent fraudsters from printing similar barcodes on a conventional printer. However, fraudsters continue to improve their methods of replicating barcodes, thereby demanding even further improvement in tamper-preventative measures currently being taken.

### SUMMARY

In one aspect of the present disclosure, a prepaid gift assembly is disclosed. The prepaid gift assembly includes a first panel coupled to a second panel. The prepaid gift assembly also includes a redemption code at least partially enclosed within the packaging and located between the first panel and the second panel, a foil disposed over the redemption code to conceal the redemption code, an activation code at least partially enclosed within the packaging, and a foil reference label disposed on an external surface of the packaging. The foil includes a printing. The activation code is located between the first panel and the second panel and positioned adjacent to the redemption code. Additionally, the foil reference label includes a reference printing that is configured for comparing to the printing of the foil to determine whether the foil remains intact.

In another aspect of the present disclosure, a prepaid gift assembly is disclosed. The prepaid gift assembly includes packaging that includes a first panel and a second panel coupled to the first panel. The prepaid gift assembly also includes a redemption code disposed on an internal surface of the second panel and located between the first panel and the second panel, a foil disposed over the redemption code to conceal the redemption code, and a foil reference label disposed on an external surface of the packaging. The redemption code is at least partially visible through a foil cutout defined by the second panel. The foil includes a serialized alphanumeric printing. Additionally, the foil reference label includes a reference serialized alphanumeric printing that is configured for comparing to the serialized alphanumeric printing of the foil to visually determine whether the foil has been tampered with.

In another aspect of the present disclosure, a prepaid gift assembly is disclosed. The prepaid gift assembly includes packaging that includes a first panel and a second panel coupled to the first panel. The prepaid gift assembly also includes a redemption code disposed on an internal surface of the second panel and located between the first panel and the second panel, a foil disposed over the redemption code to conceal the redemption code, a foil reference label disposed on an external surface of the packaging, an activation code on the internal surface of the second panel and located adjacent to the redemption code, and an activation code reference label disposed on the external surface of the packaging. The redemption code is at least partially visible through a foil cutout defined by the second panel. The foil includes a serialized alphanumeric printing. The foil reference label includes a reference serialized alphanumeric printing that is configured for comparing to the serialized alphanumeric printing of the foil to visually determine whether the foil has been tampered with. Additionally, the redemption code is at least partially visible through an activation code cutout defined by the second panel, and the activation code cutout is at least partially covered by an activation code panel defined by perforations of the second panel. Moreover, the activation code reference label includes a reference activation code that is configured for comparing to the activation code to visually determine whether the activation code has been tampered with.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a front view of a prepaid card assembly.

FIG. 1B is a rear view of the prepaid card assembly shown in FIG. 1A.

FIG. 1C is another rear view of the prepaid card assembly shown in FIGS. 1A and 1B illustrating the prepaid card assembly in a partially open state.

FIG. 1D is another rear view of the prepaid card assembly shown in FIGS. 1A-1C further illustrating the prepaid card assembly in a partially open state.

FIG. 1E is another rear view of the prepaid card assembly shown in FIGS. 1A-1D illustrating the prepaid card assembly in a fully open state.

FIG. 1F is another rear view of the prepaid card assembly shown in FIGS. 1A-1E illustrating a foil of the prepaid card assembly removed.

FIG. 2 is a close-up view of the activation code of the prepaid card assembly shown in FIGS. 1A-1F.

FIG. 3A is a rear view of another example of a prepaid card assembly in a fully open state.

FIG. 3B is another rear view of the prepaid card assembly shown in FIG. 3A illustrating a foil of the prepaid card assembly removed.

### DETAILED DESCRIPTION

The present teachings generally relate to a prepaid gift assembly. The prepaid gift assembly may include packaging that securely houses (e.g., contains) one or more items, such as a prepaid card and/or a redemption code. The packaging of the prepaid card assembly may prevent tampering with the one or items within the packaging (e.g., the prepaid card and/or the redemption code) prior to a rightful owner opening the packaging. For example, the packaging may help easily identify if the prepaid card has been removed from the packaging or if a code (e.g., a barcode and/or QR code located on the prepaid card and/or within the prepaid gift assembly) has been altered in any manner. As such, a rightful owner (i.e., a genuine consumer) of the prepaid gift assembly or a retail store selling the prepaid gift assembly may recognize that the prepaid gift assembly may no longer be valid and dispose of the prepaid gift assembly.

As stated above, the prepaid gift assembly may include or contain one or more items, such as a prepaid card and/or a redemption code. The prepaid card may be a gift card or other physical item that is loadable and/or scannable and contained within the packaging of the prepaid gift assembly. Additionally, the prepaid gift assembly may be free of any prepaid card. That is, the prepaid gift assembly my include a redemption code (e.g., a barcode, QR code, etc.) that may be disposed within the confines of the prepaid gift assembly such that a user may scan the redemption code to deposit predefined funds associated with the redemption code into their account. In such a configuration, the user may not be required to physically remove a prepaid card. As such, the teachings herein are not particularly limited to any one item contained within the packaging of the prepaid gift assembly.

As described further below, the prepaid gift assembly or portions thereof (e.g., the redemption code) may be designed to help deter fraudsters from tampering with the prepaid gift assembly. In conventional configurations, the redemption code of the prepaid gift assembly may be at least partially visible when the prepaid gift assembly is closed (e.g., in a closed state in which the prepaid gift assembly remains untorn and intact). As a result, the redemption code may be at risk of duplication. For example, fraudsters may often attempt to adhere a counterfeit code over the redemption code of the prepaid gift assembly, thereby making a genuine customer inadvertently preload a “dummy” account tied to the fraudster. Similarly, when a prepaid card is physically located within the prepaid gift assembly, fraudsters may often remove the prepaid card from the prepaid gift assembly and replace the prepaid card with a replicate, thereby making a genuine customer inadvertently preload the “dummy” account tied to the fraudster. It is envisioned that the prepaid gift assembly described herein deters tampering. Additionally, it is envisioned that the prepaid gift assembly described herein may provide easy identification of fraudulent activity and/or counterfeit prepaid cards.

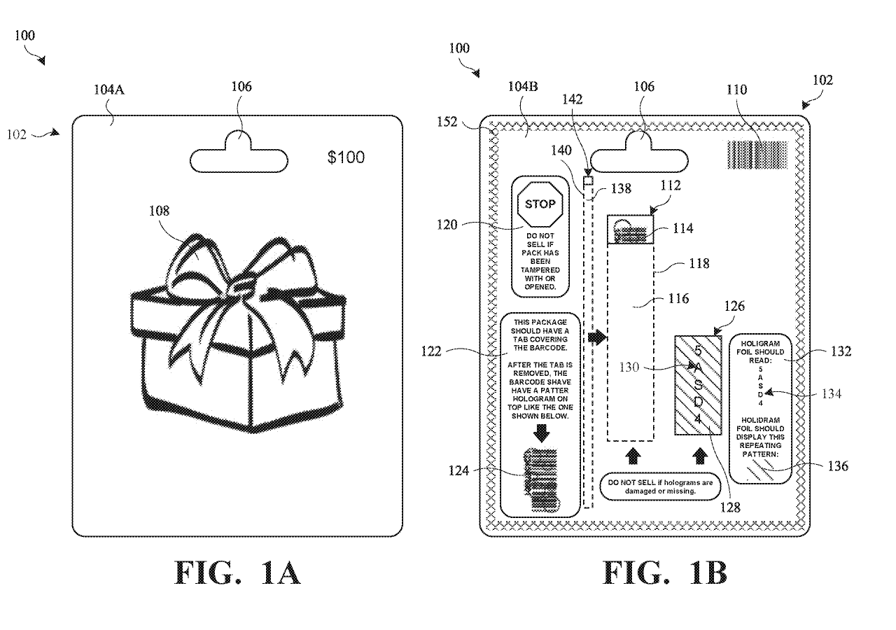

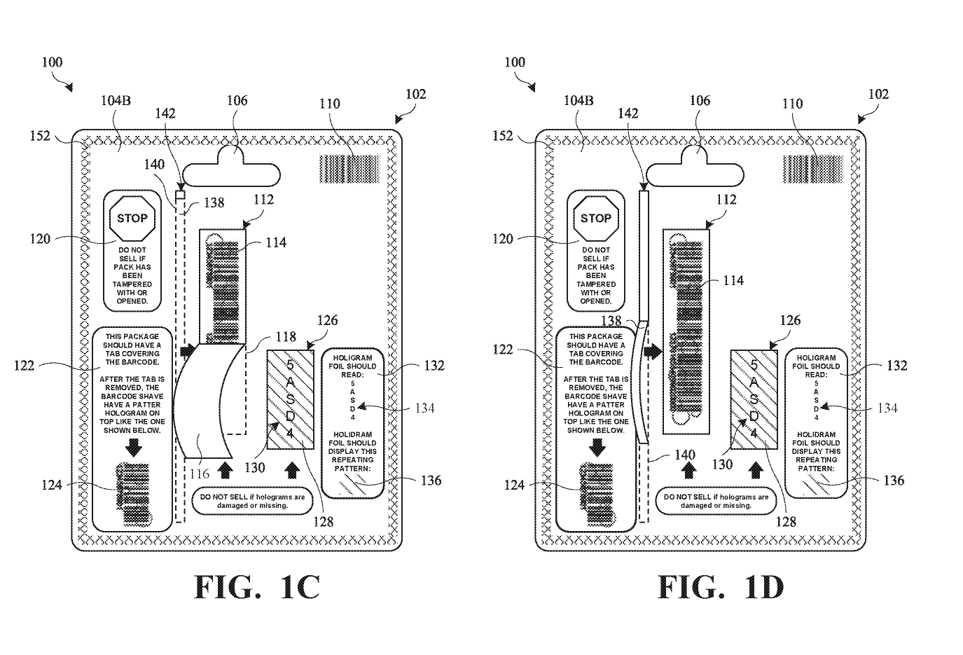

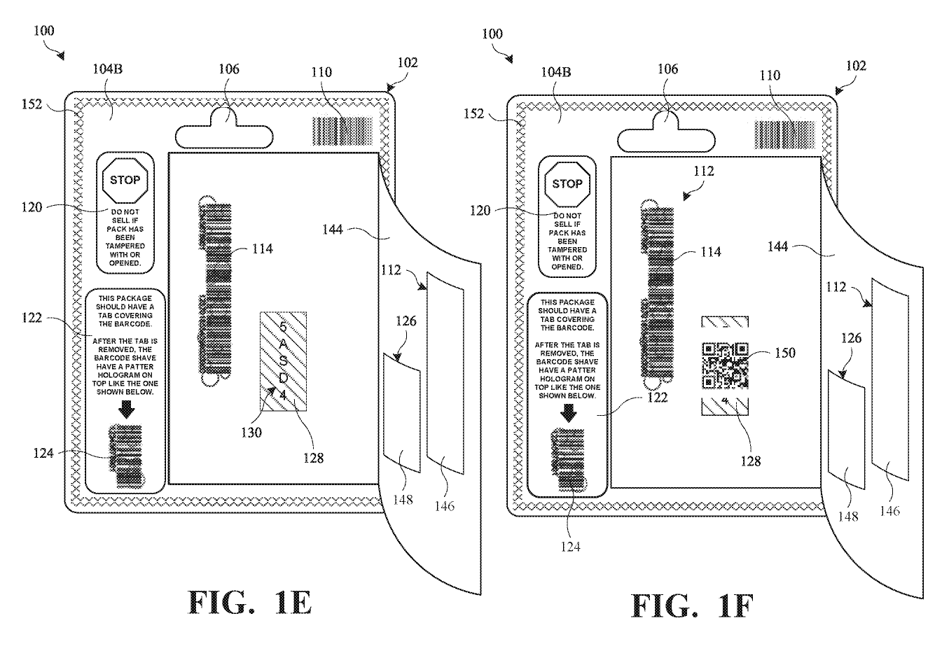

Turning now to the figures, FIGS. 1A and 1B illustrate a front view and a rear view, respectively, of a prepaid gift assembly 100. The prepaid gift assembly 100 may be or may include packaging 102 and a redemption code at least partially enclosed within the packaging 102. For example, the packaging 102 may include a first panel 104A adjoined to a second panel 104B (e.g., by one or more fold lines, via an adhesive, etc.) so that the first panel 104A and the second panel 104B may be coupled to one another such that the first panel 104A and the second panel 104B abut one another and at least partially enclose the redemption code therebetween. In an example, the packaging 102 may also include a prepaid card at least partially enclosed between the first panel 104A and the second panel 104B. The prepaid card may include or contain the redemption code. As such, the packaging 102 is not particularly limited to any type or configuration of the redemption code.

Based on the above, the first panel 104A and the second panel 104B may form an outer shell of the packaging 102 that houses the redemption code therebetween. The first panel 104A and/or the second panel 104B may include one or more layers (e.g., a composite material) or may be monolithically formed. The first panel 104A and/or the second panel 104B may be the same thickness or may have different thicknesses. For example, the first panel 104A and/or the second panel 104B may have a thickness of about 1 mm or more, about 5 mm or more, or about 10 mm or more. The first panel 104A and/or the second panel 104B may have a thickness of about 20 mm or less, about 15 mm or less, or about 11 mm or less.

The first panel 104A and the second panel 104B may also be integrally (e.g., monolithically) formed with one another. For example, the first panel 104A and the second panel 104B may die cut from a stock material (e.g., card stock, paperboard, plastic, etc.) and interconnected via a fold line located therebetween. The fold line may be a crease or partial cut (e.g., scoring) within the first panel 104A and/or the second panel 104B to provide a flexible region between the first panel 104A and the second panel 104B. The packaging 102 may also contain any number of panels and is not particularly limited to the first panel 104A and the second panel 104B. For example, the packaging 102 may be a tri-fold configuration, whereby the packaging 102 may include the first panel 104A, the second panel 104B, and a third panel.

The first panel 104A and/or the second panel 104B may define an aperture 106. The aperture 106 may provide a hanging mechanism to the packaging 102 so that the prepaid gift assembly 100 may be hung from one or more display hooks. The aperture 106 of the first panel 104A and/or the aperture 106 of the second panel 104B may be any desired size and/or shape. When the first panel 104A and/or the second panel 104B are coupled to one another, an aperture of the first panel 104A may align with an aperture of the second panel 104B to form the aperture 106 such that a display hook may extend through both the aperture of the first panel 104A and the aperture of the second panel 104B.

The first panel 104A and/or the second panel 104B may also contain one or images, text, numerical data, or a combination thereof. For example, the first panel 104A and/or the second panel 104B may contain a graphic 108, such as a gift box, to indicate the contents of the prepaid gift assembly 100. Similarly, the first panel 104A and/or the second panel 104B may indicate a value of the prepaid gift assembly 100 (e.g., a monetary value once the redemption code is activated (e.g., digitally scanned) by the customer).

Additionally, the first panel 104A and/or the second panel 104B may include an external barcode 110. The external barcode 110 may be scanned (e.g. digitally scanned, electronically scanned, etc.) by a retail establishment to inventory the prepaid gift assembly 100, may be scanned during loading (i.e., purchasing) of the prepaid gift assembly 100, may be scanned during disposal of the prepaid gift assembly 100 (e.g., if the retail establishment identifies that the prepaid gift assembly 100 has been tampered with), or a combination thereof.

Turning back to FIG. 1B, the packaging 102 may define an activation code cutout 112. For example, the first panel 104A and/or the second panel 104B may define the activation code cutout 112 therein. As shown in FIG. 1B, the second panel 104B may define the activation code cutout 112, whereby an activation code 114 may be at least partially visible through the activation code cutout 112 so that the activation code 114 may be visually reviewed (e.g., by the retail establishment and/or the customer) without opening the packaging 102. That is, the activation code cutout 112 may provide a window to visually confirm if the activation code 114 is present within the packaging 102 and intact (e.g., free of distortion, damage, etc.)

The activation code cutout 112 may be any desired size and/or shape. The activation code cutout 112 may have dimensions smaller than dimensions of the activation code 114 or may have dimensions larger than dimensions of the activation code 114. As such, the activation code cutout 112 may vary in size based upon a size of the activation code 114.

As discussed above, the activation code 114 may be at least partially visible through the activation code cutout 112. For example, only a portion of the activation code 114 may be visible through the activation code cutout 112 such that the activation code 114 remains sufficiently obstructed (e.g., covered) as to prevent scanning of the activation code 114. As shown in FIG. 1B, the activation code cutout 112 may be at least partially covered by an activation code panel 116. The activation code panel 116 may be disposed adjacent to the activation code 114 so as to cover at least a portion of the activation code 114 and prevent scanning of the activation code 114. The activation code panel 116 may be a portion of the second panel 104B or may be coupled to the second panel 104B. For example, the activation code panel 116 may be a portion of the second panel 104B, and a perimeter of the activation code panel 116 may be defined by perforations 118 in the second panel 104B. As a result, when the retail establishment or customer wishes to scan the activation code 114, the activation code panel 116 may be torn along the perforations 118 to remove the activation code panel 116 and reveal the activation code 114. Thus, if a fraudster were to attempt to tamper with the activation code 114, the fraudster would be required to remove the activation code panel 116 (e.g., via tearing along the perforations 118). However, it would be difficult or impossible for the fraudster to reapply the activation code panel 116 so as to maintain the original look of the prepaid gift assembly 100 prior to tearing the activation code panel 116. As a result, the retail establishment and/or the customer would be able to visually identify the fraudulent activity and prevent further use of the prepaid gift assembly 100.

As discussed herein, counterfeiting and tampering are common concerns within the prepaid gift industry. That is, fraudsters may seek to duplicate genuine prepaid gift assemblies (e.g., the prepaid gift assembly 100) or portions thereof such that the duplicate or “dummy” prepaid gift assembly may replace the prepaid gift assembly 100 or a respective portion thereof. As a result, a customer may inadvertently select the prepaid gift assembly 100 within the retail establishment and unintentionally load the dummy prepaid gift assembly instead of the prepaid gift assembly 100 (i.e., the genuine prepaid gift assembly), whereby the loaded funds may be inadvertently transferred to an account of the fraudster. While attempts have been made to combat such fraudulent activity, fraudsters have continued to counterfeit and tamper. For example, fraudsters may either replace the prepaid gift assembly 100 (e.g., the packaging 102) with the dummy prepaid gift assembly or may dispose a dummy barcode (e.g., a dummy barcode label) over the activation code 114.

To counteract such fraudulent activity, the prepaid gift assembly 100 may implement one or more tamper-deterrent mechanisms, such as one or more tamper-deterrent mechanisms associated with the activation code 114. For example, as discussed above, the activation code panel 116 may at least partially cover the activation code 114 to prevent tampering with the activation code 114 without visually indicating such tampering by tearing the activation code panel 116. In another example, the activation code 114 may be printed or otherwise secured to the prepaid gift assembly 100 (e.g., secured to an internal surface of the second panel 104B within the packaging 102) such that the activation code 114 is positioned entirely within the confines of the packaging 102. That is, the activation code 114 may be located within the confines of the packaging 102 such that no portion of the activation code 114 is located or otherwise disposed on an outer surface of the packaging 102 (e.g., on an outer surface of the first panel 104A and/or an outer surface of the second panel 104B).

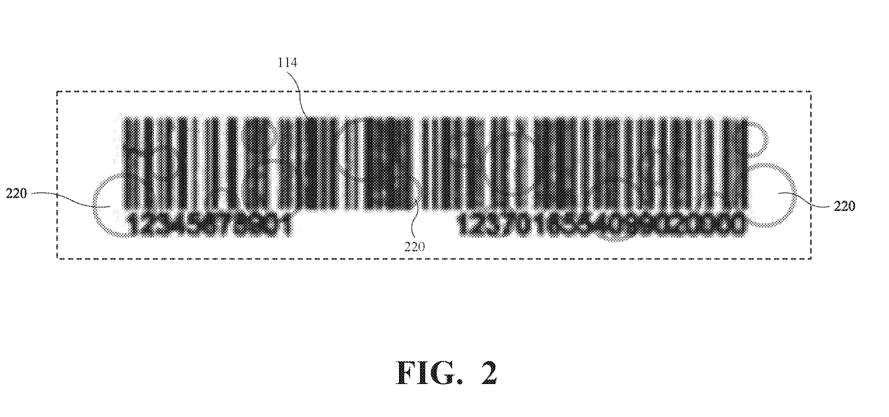

FIG. 2 illustrates a close-up view of the activation code 114 shown in FIGS. 1A and 1B. As discussed above, the activation code 114 may be disposed (e.g., printed, adhered, etc.) on an internal surface of the first panel 104A and/or the second panel 104B. As shown in FIG. 2, the activation code 114 may include a hologram 220 disposed on the activation code 114. The hologram 220 may provide a secondary visual inspection for a consumer and/or a retail establishment to identify that the activation code 114 – and thus the prepaid gift assembly 100 – is genuine. That is, the hologram 220 may function as a security measure to prevent counterfeit reproduction of the prepaid gift assembly 100 and/or tampering with the prepaid gift assembly 100.

The hologram 220 may be disposed directly over all or a portion of the activation code 114. For example, the hologram 220 may be applied to the activation code 114 as an adhesive layer or may be printed directly over the activation code 114. Advantageously, the hologram 220 may be printed over the activation code 114 such the activation code 114 may be scannable through the hologram 220. That is, the hologram 220 may be transparent or semi-transparent to facilitate such scanning of the activation code 114. The hologram 220 may be any design, shape, size, color, or a combination thereof. By way of example, as shown in FIG. 2, the hologram 220 may be a series of circles varying in size that are disposed over substantially all of the activation code 114.

The hologram 220 may provide an easy visual indication of tampering and/or counterfeiting. The hologram 220 may be reflective, translucent, or both. For example, the hologram 220 may appear to a customer or retail establishment to have depth and may be viewed from different angles as if it were a physical object. That is, the hologram 220 may form or portray a three-dimensional image (e.g., via interference of light that may reflect off the hologram 220 from various angles) that visually stands out with respect to the activation code 114. Additionally, due to the complexity of the hologram 220, it may be difficult for a fraudster to replicate the hologram 220, thereby further deterring tampering and/or counterfeiting.

By way of example, the hologram 220 may be considered a moving hologram. That is, the hologram 220 may exhibit motion or changes in perspective as a viewer of the hologram 220 alters their perspective or viewing angle of the hologram 220. The hologram 220 may contain multiple embedded images or frames that may be printed or disposed in a single holographic surface to form the hologram 220. Therefore, the hologram 220 may provide a dynamic visual indication such that the hologram 220 may appear to the user to move along the surface of the activation code 114 (e.g., along the surface of the first panel 104A and/or the surface of the second panel 104B).

The hologram 220 may be positioned anywhere relative to the activation code 114. For example, instead of being disposed directly over the activation code 114, the hologram 220 may be disposed on first panel 104A and/or the second panel 104B adjacent to the activation code 114. However, as shown in FIG. 1B, it may be beneficial to position the hologram 220 on the activation code 114 such that the hologram 220 is viewable through the activation code cutout 112.

In addition to the hologram 220, the activation code 114 may include one or more color gradients along at least a portion of the activation code 114 to vary colors of the activation code 114. The color gradients may alter a color of the activation code 114 through one or more hues, one or more color shades, or both. For example, the activation code 114 may include a first portion that is purple and a second portion that is blue. The first portion and the second portion may be connected via a connecting region of the activation code 114, whereby the connecting region may include a plurality of different shades of color spanning between purple and blue. As a result, the activation code 114 may be more difficult to reproduce, thereby further deterring tampering and/or counterfeiting.

Turning back to FIGS. 1A and 1B, the packaging 102 may also include a warning label 120 and an activation code reference label 122 that are located adjacent to the activation code 114. For example, the warning label 120 and/or the activation code reference label 122 may be disposed or printed on the second panel 104B adjacent to the activation code cutout 112. The warning label 120 may provide a visual indicator for the retail establishment or the customer to further review the packaging 102. For example, the warning label 120 may provide a general warning for the retail establishment or the customer to review the additional content disposed on the second panel 104B, such as the activation code reference label 122, to confirm that the prepaid gift assembly 100 remains intact.

In an example, the warning label 120 may include a general warning to further review the packaging 102 for any evidence of temperance and the activation code reference label 122 may include reference information about the activation code 114 to identify whether the activation code 114 is counterfeit or has been tampered with by a fraudster. For example, the activation code reference label 122 may include a description of the activation code 114, such as the design of the hologram 220 printed on the activation code 114, a description of the color gradient of the activation code 114, or both, to easily identify if the activation code 114 has been modified or tampered with. The activation code reference label 122 may also include a reference activation code 124, which may a duplicate of, or similar to, the activation code 114 such that a retail establishment or customer may compare the reference activation code 124 to the activation code 114 and confirm that that the key features (e.g., color gradient, the hologram 220 pattern, etc.) of the activation code 114 match the reference activation code 124. If the reference activation code 124 does not match the activation code 114, then the retail establishment or the customer may easily determine that the prepaid gift assembly 100 has been tampered with or is counterfeit.

The reference information of the activation code reference label 122 is not particularly limited to any type of information. For example, the reference information may include text, numerical data, visual aids (e.g., one or more objects), colors, or a combination thereof. As discussed above, the reference information may include the reference activation code 124. The reference activation code 124 may include a similar hologram to the hologram 220 of the activation code 114 to compare a design of the hologram 220. The reference activation code 124 may also include a similar color gradient for visual comparison. As such, the reference activation code 124 may provide an easy comparison for the activation code 114.

The warning label 120 and the activation code reference label 122 may be located anywhere along the packaging 102. Moreover, in some configurations, the activation code reference label 122 may be part of, or otherwise integrated into, the warning label 120, or vice versa. That is, the activation code reference label 122 may be within the confines of the warning label 120, or vice versa.

Turning back to FIG. 1B, the packaging 102 may also include a foil cutout 126. The foil cutout 126 may be similar to the activation code cutout 112. For example, the foil cutout 126 may be a window defined by the second panel 104B such that a foil 128 disposed within the packaging 102 (e.g., disposed on an internal surface of the first panel 104A and/or the second panel 104B) may be at least partially visible through the foil cutout 126. For example, a printing 130, such as alphanumeric characters, text, patterns, or other designs, may be printed on the foil 128 and may be visible through the foil cutout 126. As a result, the retail establishment or the customer may easily visually inspect the foil 128 and/or the printing 130 to further identify fraudulent activity (e.g., tampering with the foil 128).

By way of example, as discussed further below, the foil 128 may be disposed over the redemption code of the prepaid gift assembly 100. As a result, the foil 128 may provide a protective cover to conceal the redemption code prior to a genuine customer purchasing the prepaid gift assembly 100. Therefore, the retail establishment or the customer can visually inspect the foil 128 through the foil cutout 126 to determine if a fraudster has damaged (e.g., scratched off) the foil 128 to reveal the redemption code.

Additionally, in some instances, the fraudster may attempt to remove the foil 128 to reveal the redemption code to replace or cover the redemption code with a dummy (i.e., fraudulent) redemption code. In such a case, the fraudster may then attempt to replace the foil 128 with another foil to maintain the look of the prepaid gift assembly 100. However, the prepaid gift assembly 100 may also provide a tamper-evident mechanism for such a situation. For example, the packaging 102 may include a foil reference label 132 located adjacent to the foil 128 along the second panel 104B. The foil reference label 132 may be similar to the activation code reference label 122 and provide reference information related to the foil 128.

For example, the foil reference label 132 may include reference printing 134 and/or a reference pattern 136. The reference printing 134 may be visually compared, by the retail establishment or the customer, to the printing 130 of the foil 128. In an example, the printing 130 may be a unique alphanumeric code (e.g., a serial number, serial code, etc.) that is specific to the prepaid gift assembly 100. The reference printing 134 may be identical to the printing 130 such that the retail establishment or the customer may compare the reference printing 134 (e.g., a reference alphanumeric code) to the printing 130 (e.g., the alphanumeric code) to determine whether they match. If the reference printing 134 and the printing 130 do not match, then the retail establishment or the customer may determine that the foil 128 has been tampered with and the prepaid gift assembly 100 is no longer valid. Conversely, if the reference printing 134 and the printing 130 do match, then the retail establishment or the customer may determine that the foil 128 has not been tampered with and the prepaid gift assembly 100 is still valid.

Similarly, the reference pattern 136 may be visually compared, by the retail establish or the customer, to a pattern of the foil 128. The foil 128 may include a pattern, hologram (e.g., similar to the hologram 220 of the activation code 114), color gradient, or a combination thereof. The discussion above with respect to the activation code 114 shown in FIG. 2 is applicable herein with respect to the foil 128. As such, the reference pattern 136 may be compared to the foil 128 (e.g., a pattern thereof) to determine whether they match or are similar in pattern. If the reference pattern 136 is not similar to or does not match the pattern of the foil 128, then the retail establishment or the customer may determine that the foil 128 has been tampered with and the prepaid gift assembly 100 is no longer valid. Conversely, if the reference pattern 136 and the pattern of the foil 128 do match, then the retail establishment or the customer may determine that the foil 128 has not been tampered with and the prepaid gift assembly 100 is still valid. Thus, the foil 128 and the printing 130 thereon may provide an additional tamper-evident mechanism to dissuade or even prevent fraudsters from tampering with the prepaid gift assembly 100.

As discussed further below, the foil 128 may be disposed over the redemption code of the prepaid gift assembly 100, whereby the redemption code may be scanned (e.g., electronically scanned, digitally scanned, etc.) by the customer to collect (e.g., deposit) the preloaded funds associated with the prepaid gift assembly 100. The foil 128 may protect and conceal the redemption code prior to the customer scanning the redemption code. The foil 128 may be disposed over the redemption code (e.g., disposed on the first panel 104A and/or the second panel 104B in any desired manner. For example, the foil 128 may be adhered to or printed on the first panel 104A and/or the second panel 104B. The foil 128 may have any size and/or shape (e.g., the foil 128 may be larger or smaller in dimension than the foil cutout 126). The foil 128 may be any materials. For example, the foil 128 may be metallic, may be paper-based, may be polymer-based, may be a composite, or a combination thereof. The foil 128 may be any color. For example, the foil 128 may be embedded or infused with any desired ink or color particulates. Moreover, the foil 128 may be any desired thickness. By way of example, the foil 128 may be a scratch-off material such that the customer may open the packaging 102 and scratch off all or a portion of the foil 128 to reveal the redemption code beneath.

FIGS. 1B-1F will now be discussed in further detail to illustrate opening of the packaging 102 by a customer and activating (e.g., scanning) the redemption code therein. As discussed above, FIG. 1B illustrates the back side of the packaging 102 in a closed state – that is, prior to opening. As shown in FIG. 1C, when a customer purchases the prepaid gift assembly 100 from the retail establishment, the retail establishment may remove the activation code panel 116 (e.g., may tear off the activation code panel 116) to reveal the activation code 114, allowing the retail establishment to scan the activation code 114 so that the customer may purchase the prepaid gift assembly 100. That is, the activation code 114 may be associated with the retail establishment to sell the prepaid gift assembly 100 and approve subsequent activation of the prepaid gift assembly 100 by the customer.

Once the customer has purchased the prepaid gift assembly 100, the user may open the prepaid gift assembly 100 to reveal the foil 128. For example, as shown in FIG. 1B, the packaging 102 (e.g., the second panel 104B) may include a pull tab 138 defined by additional perforations 140 along the second panel 104B. As shown in FIG. 1D, the customer may grasp an end of the pull tab 138 via a pull tab cutout 142 defined by the second panel 104B and tear the pull tab 138 along the additional perforations 140. As shown in FIG. 1E, once the pull tab 138 has been torn along the additional perforations 140, the user may peel or otherwise tear open the second panel 104B to reveal the foil 128. For example, the second panel 104B may include or define a flap 144 that may be torn from the second panel 104B once the pull 138 has been torn along the additional perforations 140. The flap 144 may be torn along an associated perforation (not shown) or may be torn along scoring 152 in the second panel 104B. The scoring 152 may be an additional tamper-evidence mechanism. For example, the scoring 152 may be cuts in the first panel 104A and/or the second panel 104B such that, when the fraudster attempts to peel the first panel 104A and the second panel 104B apart, the first panel 104A and/or the second panel 104B may tear along the scoring 152 and may be unable to be properly recoupled (e.g., re-adhered) to one another.

Once the flap 144 is opened, the customer may then scratch off or otherwise remove the foil 128 to reveal the redemption code 150 shown in FIG. 1F. The redemption code 150 may be a QR code that may be scanned (e.g., digitally scanned, electronically scanned, etc.) by the customer to access the preloaded funds of the prepaid gift assembly 100. In some instances, the redemption code 150 may be a barcode, alphanumeric code, or other activatable indicia.

The flap 144 shown in FIGS. 1E and 1F may also include one or more transparent substrates the cover the activation code cutout 112 and/or the foil cutout 126. For example, an activation code transparent substrate 146 may be adhered to an interior surface of the second panel 104B to extend across the activation code cutout 112 and a foil transparent substrate 148 may be adhered to the interior surface of the second panel 104B to extend across the foil cutout 126. In some configurations, the activation code transparent substrate 146 and the foil transparent substrate 148 may be a single piece that extends across both the activation code cutout 112 and the foil cutout 126. In some instances, the second panel 104B may be a composite material that includes a transparent layer that forms the activation code transparent substrate 146 and/or the foil transparent substrate 148. In any of the above configurations, the activation code transparent substrate 146 and/or the foil transparent substrate 148 may be a transparent or semi-transparent material (e.g., a plastic material) that protects the activation code 114 and the foil 128 prior to opening the flap 144. Thus, the activation code transparent substrate 146 and/or the foil transparent substrate 148 may act as a further tamper-evident mechanism to prevent fraudsters from tampering with the activation code 114 and/or the foil 128.

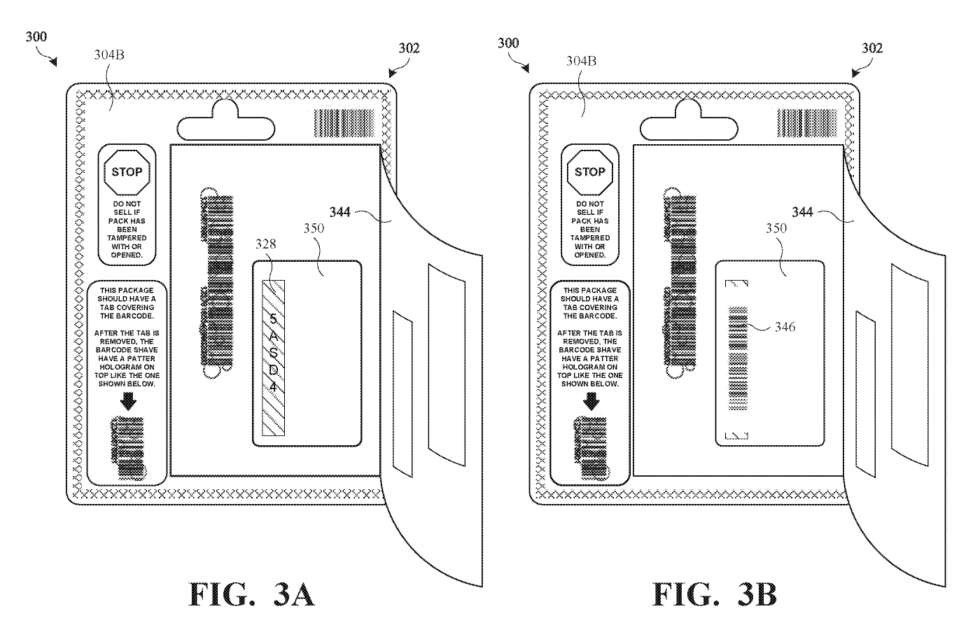

FIG. 3A and 3B illustrate a rear view of a prepaid gift assembly 300. The prepaid gift assembly 300 may be similar to the prepaid gift assembly 100 discussed above unless otherwise stated. FIG. 3A and 3B illustrates the prepaid gift assembly 300 in an open state. Similar to the prepaid gift assembly 100 shown in FIGS. 1A-1F, the prepaid gift assembly 300 may be torn open to open a flap 344 of a second panel 304B of packaging 302 of the prepaid gift assembly 300.

While the prepaid gift assembly 100 included the redemption code 150 disposed directly on an internal surface of the first panel 104A and/or the second panel 104B within the confines of the packaging 102, the prepaid gift assembly 100 may include a prepaid card 350 disposed within the packaging 302 (e.g., between a first panel and the second panel 304B of the packaging 302). In such a case, the prepaid card 350 may include a foil 328, which may be similar to the foil 128 of the prepaid gift assembly 100. The foil 328 may be disposed over an redemption code 346, which in this instance may be a barcode. As such, the customer may physically remove the prepaid card 350 from the packaging 302 to scratch off or otherwise remove the foil 328 to thereby reveal the redemption code 346. Thus, the prepaid gift assemblies 100, 300 described herein may be configured for containing a prepaid card, such as the prepaid card 350, or may be free of a prepaid card.

While the disclosure has been described in connection with certain embodiments of a sensor system, it is to be understood that the disclosure is not limited to or by the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180° ± 25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A prepaid gift assembly, comprising:
packaging that includes a first panel coupled to a second panel; and
a redemption code at least partially enclosed within the packaging and located between the first panel and the second panel;
a foil disposed over the redemption code to conceal the redemption code, wherein the foil includes a printing;
an activation code at least partially enclosed within the packaging, located between the first panel and the second panel, and positioned adjacent to the redemption code; and
a foil reference label disposed on an external surface of the packaging, wherein the foil reference label includes a reference printing that is configured for comparing to the printing of the foil to determine whether the foil remains intact.

2. The prepaid gift assembly of claim 1, wherein the packaging defines an activation code cutout, and the activation code is at least partially visible through the activation code cutout.

3. The prepaid gift assembly of claim 2, wherein the activation code is at least partially covered by an activation code panel defined by perforations in the second panel, and wherein the activation code panel is configured for tearing along the perforations to disconnect the activation code panel from the second panel.

4. The prepaid gift assembly of claim 2, wherein the packaging defines a foil cutout, and the foil is at least partially visible through the foil cutout.

5. The prepaid gift assembly of claim 1, wherein the redemption code is disposed on an internal surface of the first panel or the second panel.

6. The prepaid gift assembly of claim 1, wherein the printing of the foil is an alphanumeric code and the reference printing is a reference alphanumeric code, and wherein the reference alphanumeric code is configured for comparing to the alphanumeric code to determine whether the foil remains intact.

7. The prepaid gift assembly of claim 6, where the foil is a scratch-off material that is configured for scratching off to reveal the redemption code.

8. The prepaid gift assembly of claim 7, wherein the redemption code is a QR code.

9. The prepaid gift assembly of claim 1, wherein the foil includes a pattern, and wherein the foil reference label includes a reference pattern that is configured for comparing to the pattern of the foil to determine whether the foil remains intact.

10. The prepaid gift assembly of claim 9, wherein the pattern includes a hologram, a color gradient, or both.

11. The prepaid gift assembly of claim 1, wherein the packaging includes an activation code reference label located adjacent to the activation code, and wherein the activation code includes reference information about the activation code to identify counterfeiting or tampering with the activation code.

12. The prepaid gift assembly of claim 11, wherein the reference information includes a reference activation code that is configured for comparing to the activation code to identify counterfeiting or tampering with the activation code.

13. The prepaid gift assembly of claim 11, wherein the activation code includes a hologram disposed over the activation code, and wherein the activation code is configured for scanning through the hologram.

14. The prepaid gift assembly of claim 13, wherein the activation code includes a color gradient that varies colors of the activation code.

15. A prepaid gift assembly, comprising:
packaging that includes:
a first panel; and
a second panel coupled to the first panel;
a redemption code disposed on an internal surface of the second panel and located between the first panel and the second panel, wherein the redemption code is at least partially visible through a foil cutout defined by the second panel;
a foil disposed over the redemption code to conceal the redemption code, wherein the foil includes a serialized alphanumeric printing; and
a foil reference label disposed on an external surface of the packaging, wherein the foil reference label includes a reference serialized alphanumeric printing that is configured for comparing to the serialized alphanumeric printing of the foil to visually determine whether the foil has been tampered with.

16. The prepaid gift assembly of claim 15, wherein the foil is a scratch off material that is configured for scratching off to reveal the redemption code, and wherein the redemption code is digitally scannable to electronically collect preloaded funds associated with the prepaid gift assembly.

17. The prepaid gift assembly of claim 15, wherein the reference serialized alphanumeric printing configured for comparing to the serialized alphanumeric printing of the foil to visually determine whether the foil is counterfeit.

18. The prepaid gift assembly of claim 15, wherein the first panel and the second panel are integrally formed with one another.

19. The prepaid gift assembly of claim 15, further comprising:
an activation code on the internal surface of the second panel and located adjacent to the redemption code, wherein the redemption code is at least partially visible through an activation code cutout defined by the second panel, and wherein a hologram is disposed over the activation code.

20. A prepaid gift assembly, comprising:
packaging that includes:
a first panel; and
a second panel coupled to the first panel;
a redemption code disposed on an internal surface of the second panel and located between the first panel and the second panel, wherein the redemption code is at least partially visible through a foil cutout defined by the second panel;
a foil disposed over the redemption code to conceal the redemption code, wherein the foil includes a serialized alphanumeric printing;
a foil reference label disposed on an external surface of the packaging, wherein the foil reference label includes a reference serialized alphanumeric printing that is configured for comparing to the serialized alphanumeric printing of the foil to visually determine whether the foil has been tampered with;
an activation code on the internal surface of the second panel and located adjacent to the redemption code, wherein the redemption code is at least partially visible through an activation code cutout defined by the second panel, and wherein the activation code cutout is at least partially covered by an activation code panel defined by perforations of the second panel; and
an activation code reference label disposed on the external surface of the packaging, wherein the activation code reference label includes a reference activation code that is configured for comparing to the activation code to visually determine whether the activation code has been tampered with.
